(19) United States
(12) Patent Application Publication
(10) Pub. No.: US 2004/0165734 A1
(43) Pub. Date: Aug. 26, 2004

(54) Audio system for a vehicle

(76) Inventor: Bing Li, Toledo, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/808,660

(22) Filed: Mar. 25, 2004

Related U.S. Application Data
(63) Continuation-in-part of application No. 10/393,172, filed on Mar. 20, 2003.
(60) Provisional application No. 60/534,758, filed on Jan. 7, 2004.

(51) Int. Cl. H04B 1/00; G11B 7/085

(52) U.S. Cl. 381/86; 455/345; 381/389

(57) ABSTRACT

An audio system includes a housing. Within the housing, a processor is communicably connected to a compact disc drive, a user interface, a hard drive, and an audio output. Optionally, a tuner and memory may be connected to the processor and disposed within the housing. A face plate including a portion of the user interface may be removably attached to the housing. The processor is configured to read data from a compact disc within the compact disc drive or from the tuner. The processor can encode the data into digitally formatted files, and store the files within the memory or hard drive. The processing means can read, encode, and store the data at a rate equal to or faster than the normal rate of play of the data. The processing means can produce an audio signal representative of the data in one of the files stored within the memory or hard drive.

### CROSS REFERENCE TO RELATED APPLICATIONS

This application is a continuation-in-part of U.S. patent application Ser. No. 10/393,172, filed Mar. 20, 2003 and claims the benefit of U.S. Provisional Application No. 60/534,758, filed Jan. 7, 2004, the disclosures of both applications are incorporated herein by reference.

### TECHNICAL FIELD

This invention relates in general to audio systems. More particularly, this invention pertains to an audio system for a vehicle.

### BACKGROUND OF THE INVENTION

Traditionally, audio systems for vehicles have been designed to fit within the instrument panel of the vehicle, and the audio systems are then connected to speakers that are distributed throughout the vehicle. As the complexity and quantity of components included in audio systems for vehicles has increased, it has become necessary to place other portions of the audio system outside of the instrument panel, due to the limited space often available in instrument panels. For example, larger components of the audio system, such as multi-disc CD arrays, have been located in the cargo area of the vehicle. Most of these audio systems are designed such that the control portion of the audio system is integrated into the vehicle instrument panel.

Vehicle instrument panels can be designed with standardized mounting spaces for components such as audio or video systems. The mounting space in the instrument panel and the housing of the audio system may be any size or shape, and may conform to a standard specification, such as a single DIN (Deutsche Industrie Norm), a standard of the Deutsches Institut fuer Normung. The mounting space and housing may be limited to a particular size within the instrument panel due to the limited space available within the vehicle instrument panel. The mounting space within the instrument panel limits the size of the components that can be mounted within the instrument panel.

A typical audio system may include various components, such as an AM/FM tuner, a digital tuner, and a CD player. Such audio systems for vehicles require the music media, such as a compact disc, to be carried along with the player. Therefore, to listen to a variety of music, multiple media may be required. Carrying multiple media in the vehicle, especially sensitive media like compact discs, may be undesirable due to the increased opportunity for theft of the media from the vehicle and increased likelihood of damage to the media due to the storage conditions within the vehicle.

It is known that audio tracks from a media, such as a compact disc, may be converted into a compressed file format and stored for later retrieval and play. Several known digital file compression formats exist, such as WMA (Windows Media Audio), OGG Vorbis™, ATRAC (Adaptive Transform Acoustic Coding), MLP (Meridian Lossless Packing), AC-3 (Audio Compression-3), MP3 (Moving Picture Expert Group 1 Audio Layer-3), and MP3Pro. Portable MP3 players are devices that can store files formatted in MP3 format, and then retrieve and produce an audio signal representative of the MP3 file. Portable MP3 players eliminate the need for carrying all of the desired media with the audio system. However, portable MP3 players require a computer or other conversion device to transfer MP3 files to the MP3 player for storage. The computer or other device contains the processing means, hardware, and software necessary for converting the audio tracks into MP3 file format. To operate the computer or other conversion device and the software for converting and storing audio tracks requires knowledge beyond that of many consumers. Although attempts have been made to simplify this conversion software, the consumer perception of the skill level required to operate such a device deters potential buyers for fear of lack of enough knowledge to successfully operate such a device. Additionally, the use of the computer or other device conveys the perception of a complicated and time consuming process to reap the benefits of the MP3 player. Such a conventional system including a computer for converting audio tracks is not suited for convenient use within a vehicle.

Therefore, it would be advantageous to develop an audio system for a vehicle that is capable of retaining the audio tracks from multiple media without requiring the use of a computer or other complicated device, and is sized to fit within the limited mounting space provided in an instrument panel.

### SUMMARY OF THE INVENTION

The above objects as well as other objects not specifically enumerated are achieved by an audio system of this invention.

The audio system is configured to be mounted in a vehicle. The audio system includes a housing and a processing means communicably connected to a compact disc drive, a user interface, memory, and an audio output. The processing means, compact disc drive, user interface, and memory are disposed within the housing. A hard drive is disposed within the housing and is communicably connected to the processing means such that the hard drive is readily removable from the housing. Preferably, the hard drive has a storage capacity of at least 10 Gigabytes. The processing means is configured to read data from a compact disc within the compact disc drive, encode the data into digitally formatted files, and store the files within the memory or the hard drive. The processing means is configured to send an audio signal representative of the data in the stored files to the audio output. The housing may meet the specifications of the single DIN standard, although such is not required.

According to this invention, there is also provided an alternate embodiment of the audio system that is similar to the audio system described above, except that the housing meets the specifications of the single DIN standard. The audio system further includes a hard drive. The hard drive is preferably mounted within the housing and connected to the processing means to be readily removable by a user.

According to this invention, there is also provided an alternate embodiment of the audio system that is also similar to the second audio system described above, except that the housing may be any size or shape, and conform to the specifications of any standard. The processing means of this embodiment of the audio system is configured to read data from a compact disc within the compact disc drive, encode the data into digitally formatted files, and store the files within the hard drive, with the reading, encoding, and storing of the data occurring at a rate equal to or faster than a normal rate of play of the data. The hard drive is readily removable and is adapted to be communicably connected to a device that is external to the housing when the hard drive is removed from the audio system.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a block diagram of an audio system mounted within a vehicle instrument panel in accordance with this invention.

FIG. 2 is a block diagram of a processing means of the audio system illustrated in FIG. 1.

FIG. 3 is a perspective view of the audio system illustrated in FIG. 1.

FIG. 4 is a perspective view of the audio system illustrated in FIGS. 1 and 3.

FIG. 5 is a perspective view of the audio system illustrated in FIGS. 1, 3, and 4 with a portion of the audio system positioned to facilitate loading the compact disc drive of the audio system.

FIG. 6 is a perspective view of the audio system illustrated in FIGS. 1, 3, 4, and 5 with a portion of the audio system positioned to facilitate the removal of the hard drive of the audio system.

FIG. 7 is a perspective view of the hard drive illustrated in FIG. 6 connected to a computer device after removal from the audio system illustrated in FIGS. 1, 3, 4, and 5.

FIG. 8 is a perspective view of the audio system illustrated in FIGS. 1, 3, 4, 5, and 6 with a portion of the audio system removed and the hard drive partially removed from the audio system.

FIG. 9 is a plan view of the audio system illustrated in FIGS. 1, 3-6, and 8.

### DETAILED DESCRIPTION OF THE PREFERRED EMBODIMENT

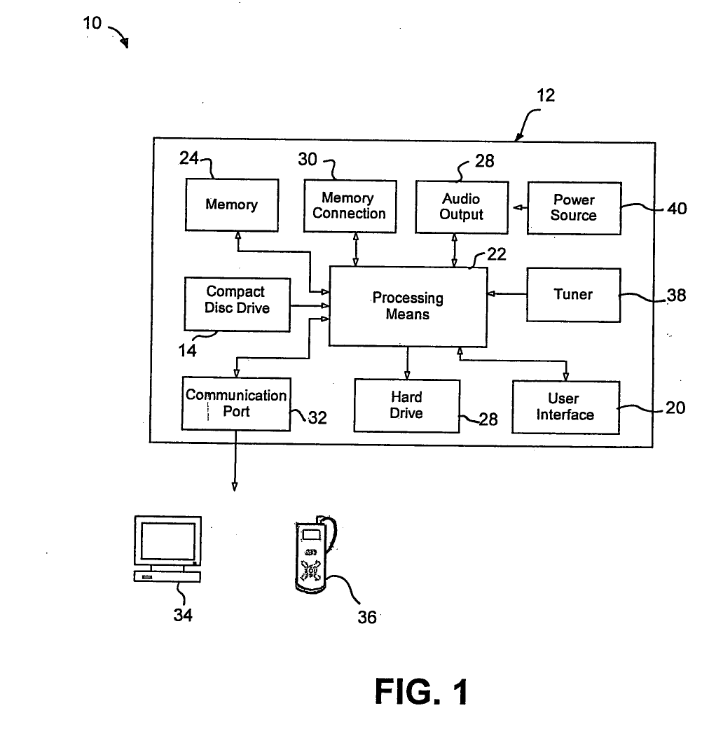

Referring now to the drawings, there is illustrated in FIG. 1 an audio system, indicated generally at 10, in accordance with this invention. An audio system capable of retaining the audio tracks from multiple media without requiring the use of a computer or other complicated device, similar in function to the audio system described herein, is described in copending U.S. patent application Ser. No. 10/393,172, filed Mar. 20, 2003, which is incorporated herein by reference.

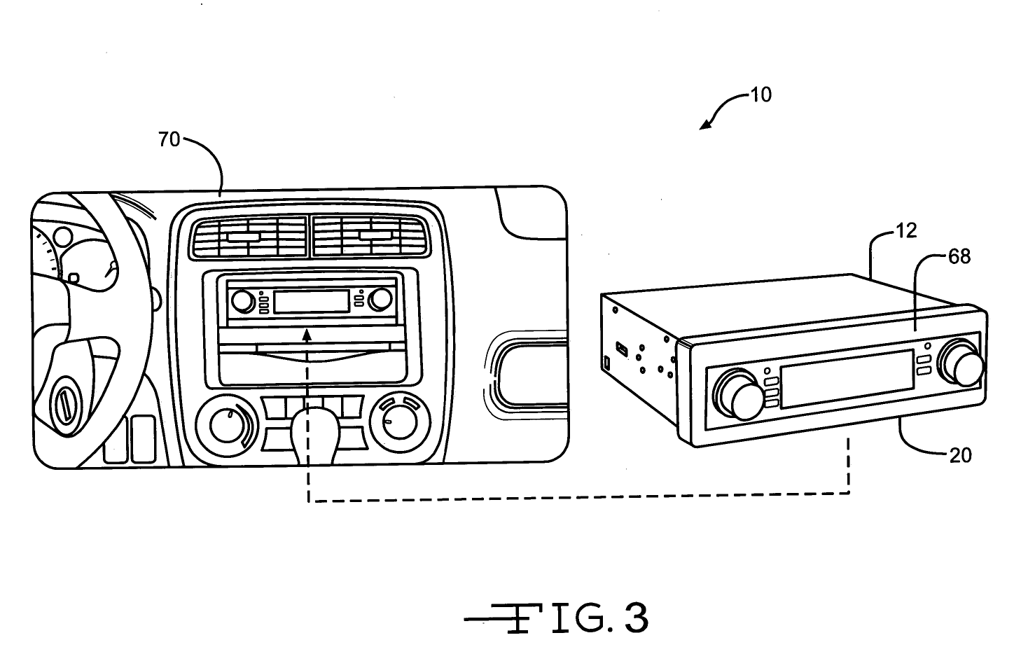

The audio system 10 includes a housing 12. The housing 12 encloses the components of the audio system 10. The housing 12 may include various mounting apertures or rails, as will be described below in reference to FIGS. 3 through 8. The audio system 10 includes a compact disc drive 14 that is capable of reading the data stored on a compact disc, not shown, in several conventional formats, preferably CD-DA (digital audio—ICE 908), CD-ROM (computer data ISO/ICE 10149), SACD (Super Audio CD), and DVD-A (DVD Audio) format. In a most preferred embodiment, the compact disc drive 14 is only capable of reading data stored on a compact disc in CD-DA format. The compact disc drive 14 may be any size and shape, and is preferably sized to fit within the audio system for a vehicle as described herein. In a preferred embodiment, the compact disc drive 14 can withstand shock strength up to 150 G for a shock duration of 11 milliseconds. The audio system 10 is communicable connected to the compact disc drive 14 and may be connected to the compact disc drive 14 by any communicably connectable corresponding interfaces (not shown), such as IDE/ATA (integrated drive electronics or AT attachment), SCSI (Small Computer System Interface), PCI (Peripheral Component Interconnect) interfaces, or other multi-pin corresponding interfaces.

The audio system 10 includes a user interface 20, a processing means 22, memory 24, and an audio output 26. The user interface 20 of the audio system 10 is configured to allow a user to input commands to control the audio system 10. The user interface 20 also communicates information regarding the operation of at least one of the compact disc drive 14 and the audio system 10. The user interface 20 may include at least one of a button, track ball, and touch screen device to allow a user to input various commands. The user interface 20 of the audio system 10 may include at least one of a LCD (liquid crystal display), a VFD (vacuum fluorescent display), a OLED (organic light emitting device), any type of voice recognition software or voice commander, and any other type of display screen to indicate such information as the command line and file contents of the audio system. The user interface 20 may include a display that allows a user to select various displayed options using at least one of a button, track ball, and touch screen device, as is best shown in FIG. 9.

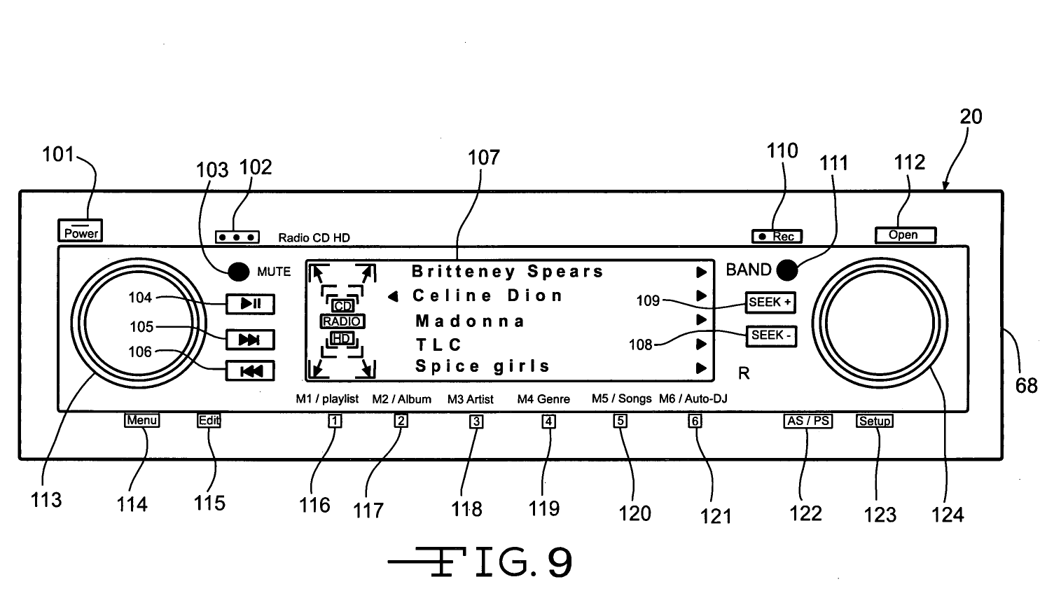

The processing means 22 of the audio system 10 is configured to read data from a compact disc, shown in FIGS. 5 and 8, loaded within the compact disc drive 14. The processing means 22 can determine if the data is in an appropriate storable format, such as a digital compression format, including formats such as WMA (Windows Media Audio), OGG Vorbis™, ATRAC (Adaptive Transform Acoustic Coding), MLP (Meridian Lossless Packing), AC-3 (Audio Compression-3), MP3 (Moving Picture Expert Group 1 Audio Layer-3), and MP3Pro. If the processing means 22 determines that the data is in an appropriate storable format, the processing means 22 can store the files within the memory 24 of the audio system 10 while the audio system 10 is connected to the compact disc drive 14. If the processing means 22 determines that the data is in a format that is not an appropriate storable format, the processing means 22 can encode the data into files in a storable format, and can store the files within the memory 24 of the audio system 10 while the audio system 10 is connected to the compact disc drive 14. Again, the storable format files may be any appropriate storable format file, such as a digital compression format described above. In a preferred embodiment, the processing means 22 encodes the data into files in MP3 format. Preferably, the reading, determination of format, potential encoding, and storing of the data occurs at a rate equal to or faster than the normal rate of play of the compact disc data. In a preferred embodiment, the processing means 22 can read data in at least one of CD-DA, SACD, and DVD-A format and encode the data into a digital compression format with up to a sampling rate of about 384 kbps. However, it will be appreciated that the sampling rate may be any rate including a rate higher than that described for the preferred embodiment.

The processing means 22 is configured to read, encode, and store the data of the compact disc while simultaneously producing an audio signal representative of the data of the compact disc. The processing means 22 can read, encode and store the data at a rate faster than the rate of normal play of the data, or the processing means 22 can read, encode, store, and produce an audio signal representative of the data at the rate of normal play of the data. Alternatively, the processing means 22 could read, encode, and store the data at a rate faster than the rate of normal play of the data, while simultaneously producing an audio signal representative of the data at the rate of normal play of the data. It will be appreciated that the processing means 22 could produce the audio signal from the compact disc data or the stored data using any suitable buffering system to ensure the continuity of the audio signal. The processing means 22 of the audio system 10 may be able to produce an audio signal representative of the data of the compact disc within the compact disc drive 14 while the audio system 10 is connected to the compact disc drive 14, although such is not required. The processing means 22 of the audio system 10 may also produce an audio signal representative of the data in one or more of the files stored within the memory 24, with the signal corresponding to the data of the compact disc within the compact disc drive. The audio signal produced by the processing means 22 is described throughout this application as being representative of the data in the stored files. However, it will be appreciated that the audio signal being representative of the data in the stored files defines the audio signal as corresponding to a stream of audio representing a portion of the data, such as a portion of the data that represents an audio track or a song.

In a preferred embodiment, the processing means 22 can encode data from the compact disc in CD-DA format at a rate approximately ten (10) times faster than the rate of normal play of the data, although it will be appreciated that the encoding rate can be any rate, and may be between one (1) and twenty (20) times faster than the rate of normal play of the data. In a preferred embodiment, the processing means 22 can convert an entire compact disc in CD-DA format in a time of about 7 minutes or less, although it will be appreciated that some compact discs will take longer to be converted due to the quality of the compact disc or the quantity of data or songs stored on the compact disc, for example some compact discs may take about 20 minutes to be converted.

The memory 24 may be any memory device suitable for storing the digital data or for buffering data for the processing means 22. It will be appreciated that the memory 24 may be integrated into the processing means 22 and may only have minimal storage capacity as needed for the processing means 22 to perform the functions described herein. The memory 24 may be any memory device, including a magnetic, optical, or removable flash memory device or solid-state floppy disk card, such as CompactFlash Type I or Type II developed by Sandisk®, SD™ (Secure Digital) by Sandisk®, Smart Media developed by Toshiba, Memory Stick® developed by Sony, xD-Picture Card by Fuji, the micro-optical media available from Data Play, or any PCMCIA Type I or Type II memory card or memory stick. In a preferred embodiment, the memory 24 is capable of holding between about 200 and about 500 digital compression format representations of songs. It is to be understood that the memory may be configured to store any number of songs. In a preferred embodiment, the memory 24 may store up to about 2 gigabytes of data, although larger memories can also be provided.

The audio output 26 may be any suitable output capable of conveying an analog audio signal produced by the processing means 22, including traditional output jacks for communicable connection with amplification devices such as earphones or other speakers.

Preferably, the audio system 10 includes a hard drive 28. The hard drive 28 may be any magnetic media device capable of storing data, including a conventional Winchester disk drive, a cartridge drive, or a microdrive, such as is available from Pockey Drives or Iomega®. In a preferred embodiment, the hard drive 28 is communicably connected to the audio system 10 and mounted to the audio system 10 such that the hard drive 28 may be readily removable from the audio system 10. The audio system 10 and the hard drive 28 may include cooperating communicable connections to facilitate the removal of the hard drive 28, as will be described below. In a preferred embodiment, the hard drive 28 has more than 10 Gigabytes of storage capacity. In a more preferred embodiment, the hard drive 28 is a USB 2.0 hard drive with about 20 Gigabytes of storage capacity or the capacity to store about 5,000 compression format representations of songs or audio tracks. In a preferred embodiment, the audio system 10 can perform all of the functions described herein in which the hard drive 28 is not required when the hard drive 28 is removed from the audio system 10. In a preferred embodiment, only one of the memory 24 and the hard drive 28 are included in the audio system 10. The processing means 22 of the audio system 10 may be adapted to store the files in a storable format within the hard drive 28, the memory 24, or both. In a preferred embodiment the memory 24 is integral to the processing means 22, and the processing means stores all files within the hard drive 28. The processing means 22 may read the data stored on the hard drive 28 and produce an audio signal representative of the stored data.

The audio system 10 may further comprise at least one optional connection 30 for communicably connecting additional memory devices for use by the processing means 22, although such is not required. The connection 30 may be at least one memory slot adapted to communicably connect at least one memory device to the processing means 22. The connection 30 may be adapted to communicably receive at least one memory device, including magnetic, optical, or removable flash memory devices (solid-state floppy disk cards), such as CompactFlash Type I or Type II developed by Sandisk®, SD™ (Secure Digital) by Sandisk®, Smart Media developed by Toshiba, Memory Stick® developed by Sony, xD-Picture Card by Fuji, the micro-optical media available from Data Play, or any PCMCIA Type I or Type II memory card or memory stick. In a preferred embodiment, the connection 30 is one memory slot.

The audio system 10 may further optionally include a communication port 32 capable of transferring data in any digital format. The communication port 32 may be any suitable communication port, such as a USB (Universal Serial Bus) port, a wired network port, Bluetooth, IrDA (Infrared Data Association), Fire Wire (IEEE 1394 High Performance Serial Bus), Wi-Fi (Wireless Fidelity) or HomeRF, or other to wireless port compliant with IEEE 802.11A or 802.11B specifications. The audio system 10 may adapted to communicate with an external computer 34 through the communication port 32. The external computer 34 may be any external device, such as a personal computer, an automated teller machine, or a server. Additionally, or alternatively, the audio system 10 may be adapted to communicate with a separate similar audio system 10 through the communication port 32. The audio system 10 may communicate stored data from the memory 24 or the hard drive 28 through the communication port 32. The audio system 10 may also receive data from the communication port 32. In a preferred embodiment, the audio system 10 may send and additionally or alternatively receive commands through the communication port 32 to control the operation of at least one of the compact disc drive 12 and the audio system 10. In a preferred embodiment, the audio system 10 may exchange stored files with the similar audio system 10. In a preferred embodiment, the audio system may send and receive data through the communication port 32 to send the unique table of contents of the compact disc within the compact disc drive 14, and the audio system may receive data related to the compact disc identified by the unique table of contents. The data received may be provided from the CDDB (Compact Disc Database by Gracenote) or any other source. It will be appreciated that this data transfer may be facilitated by the use of the computer 34 or another device connected to the communication port 32. It will be appreciated that the audio system 10 could interface and transfer data directly to an online database, such as CDDB, without the aid of the computer 34 or any other local device.

The audio system 10 may include a tuner 38 to receive and interpret at least one of AM, FM, and digital signals. The processing means 22 may be configured to read, encode, and store the data from the tuner 38 while an audio signal representative of the data from the tuner 38 is generated, although such is not required. The audio stream from the tuner 38 may be a conventional AM or FM tuner, or a digital tuner or receiver. The processing means 22 may be able to produce an audio signal representative of the data from the tuner 38.

The audio system 10 is connected to the power source 40 of the vehicle (not shown). The power supplied through the power source 40 may power the components of the audio system 10 in any suitable manner.

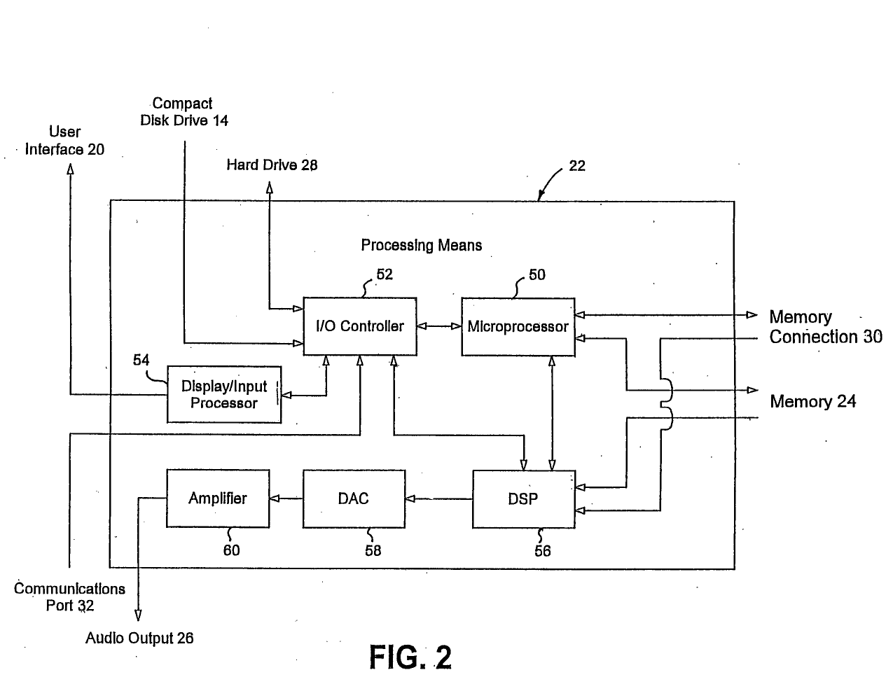

Referring now to FIG. 2, there is illustrated the processing means 22 of the audio system 10, which is shown in FIG. 1. The processing means 22 includes a microprocessor 50, which may be any suitable microprocessor device. In a preferred embodiment, the microprocessor 50 is a modified system-on-chip, such as one of the Model Nos. EP7312 and EP9312 manufactured by Cirrus Logic®. The microprocessor 50 is communicably connected to the memory 24, and may read and write data to the memory 24. An I/O controller 52 is communicably connected to the microprocessor 50. The input and output of the microprocessor 50 is controlled by the I/O controller 52. The I/O controller is also communicably connected to the compact disc drive 14, the hard drive 28, the communications port 32, and a display/input processor 54. The display/input processor 54 manages the data transferred to and input received from the user interface 20. It will be appreciated that the I/O controller 52 and the display/input processor 54 may be combined into a single device. A DSP (digital signal processor) 56 may be communicably connected to the microprocessor 50, although such is not required. It will be appreciated that the microprocessor 50 may be capable of performing the operations described herein of the DSP 56 without a separate DSP device. Further, it is contemplated that the microprocessor 50 and the DSP 56 may be integrated into a single device. Alternatively, it is also contemplated that the microprocessor 50 may be a DSP device, such that a separate DSP device is not required. The DSP 56 is controlled by the microprocessor 50. The DSP 56 can retrieve digitally compressed data from the memory 24, the memory connection 30, the compact disc drive 14, the hard drive 28, and the communications port 32 via the I/O controller 52. The DSP 52 runs a decompression algorithm on the digitally compressed data. In a preferred embodiment, the DSP 52 may be one of DSP Model Nos. TMS320C6211, TMS320C6211B, TMS320C6411, and TMS320C6711 manufactured by Texas Instruments. The DSP 52 then outputs the decompressed data to a DAC (digital-to-analog converter) 58. The DAC 58 converts the data into an analog signal, and transmits the analog signal to an amplifier 60. The amplifier 60 boosts the strength of the signal and transmits the analog signal to the audio output 26.

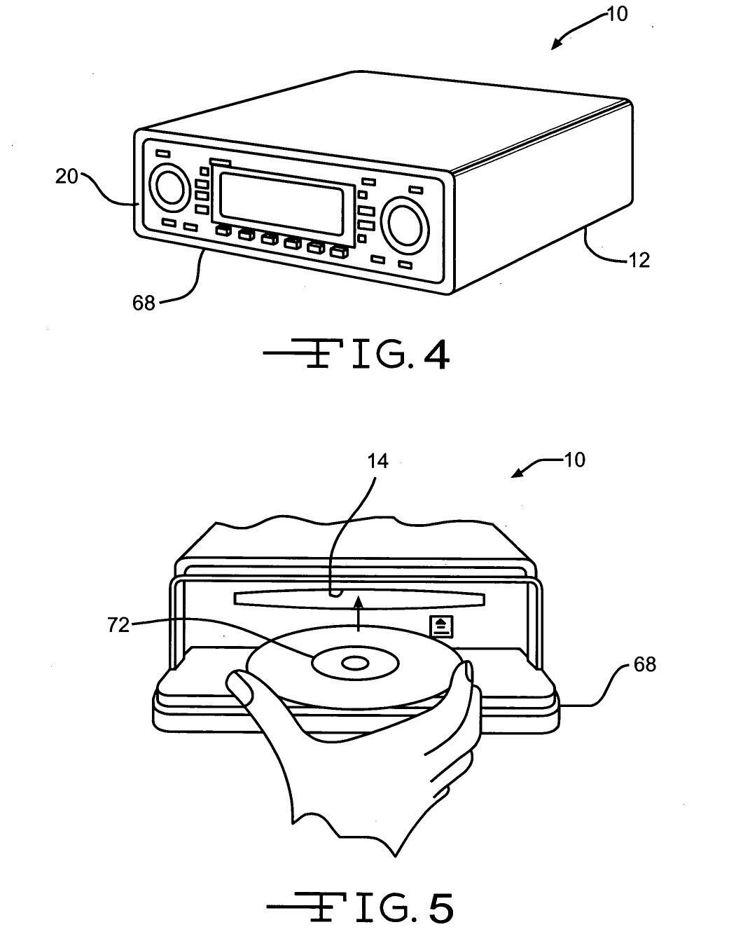

Referring now to FIGS. 3 and 4, the audio system 10 and housing 12 are illustrated. The audio system 10 further includes a face plate 68. The housing 12 and the face plate 68 enclose the above-described components of the audio system 10, except that at least a portion of the user interface 20 is exposed through the face plate 68.

In FIG. 4, the audio system 10 is additionally illustrated mounted within an instrument panel 70 of a vehicle. The illustrated instrument panel is, in large measure, conventional in the art and is intended merely to illustrate one environment in which this invention may be used. Thus, the scope of this invention is not intended to be limited for use with the specific structure for the instrument panel that is illustrated in FIG. 1 or with vehicle instrument panels in general. On the contrary, as will become apparent below, this invention may be used in any desired environment for the purposes described below.

When mounted within the instrument panel 70, the housing 12 is disposed within the instrument panel 70 in a manner such that the housing 12 is not visible from within the occupant compartment of the vehicle. The audio system 10 is mounted within the instrument panel 70 in a manner such that the face plate 68 is visible and accessible from the occupant compartment of the vehicle.

The housing 12 may be sized to conform to ISO (International Organization for Standardization) or DIN (Deutsche Industrie Norm) standard specifications. In a preferred embodiment, the housing 66 conforms to the single DIN standard or DIN Standard No. 75 500 that specifies that the mounting space be 180 millimeters in width, 52 millimeters in height and 170 millimeters in depth. In an alternate embodiment, the housing 66 conforms to the double DIN standard. The housing 12 may conform to the specifications of an ISO-mount or DIN-mount audio component. An ISO-mount audio component is characterized by a standard body size and includes a standard pattern of mounting holes on the vertical sides of the component. Similarly, a DIN-mount unit has a standard body size, but unlike the ISO-mount component, it utilizes a DIN cage for mounting within a DIN-specific aperture. It will be appreciated that the housing 12 may be any size or shape, and may conform to a standard specification for component mounting spaces in vehicles, such as a single DIN (Deutsche Industrie Norm), a standard of the Deutsches Institut fuer Normung, or a double DIN or ISO standard.

Referring now to FIG. 5, the face plate 68 may be detachable from the compact disc drive 14, although such is not required. Alternatively or additionally, face plate 68 may be movable from a first position in which the face plate 68 is relatively flush with the instrument panel to a position in which the face plate 68 is relatively perpendicular to the instrument panel to facilitate loading a compact disc 72 within the compact disc drive 14, as shown in FIGS. 5 and 8. It will be appreciated that the face plate 68 may be connected to the audio system 10 by any suitable means to facilitate movement between the first and second position, such as a hinge connected to both the audio system 10 and the face plate 68. The face plate 68 may include at least a portion of the user interface 20. The face plate 68 and the housing 66 may include cooperating communication interfaces (not shown) to communicably connect the portion of the user interface 20 to the audio system 10 when the face plate 68 is attached to the housing 66.

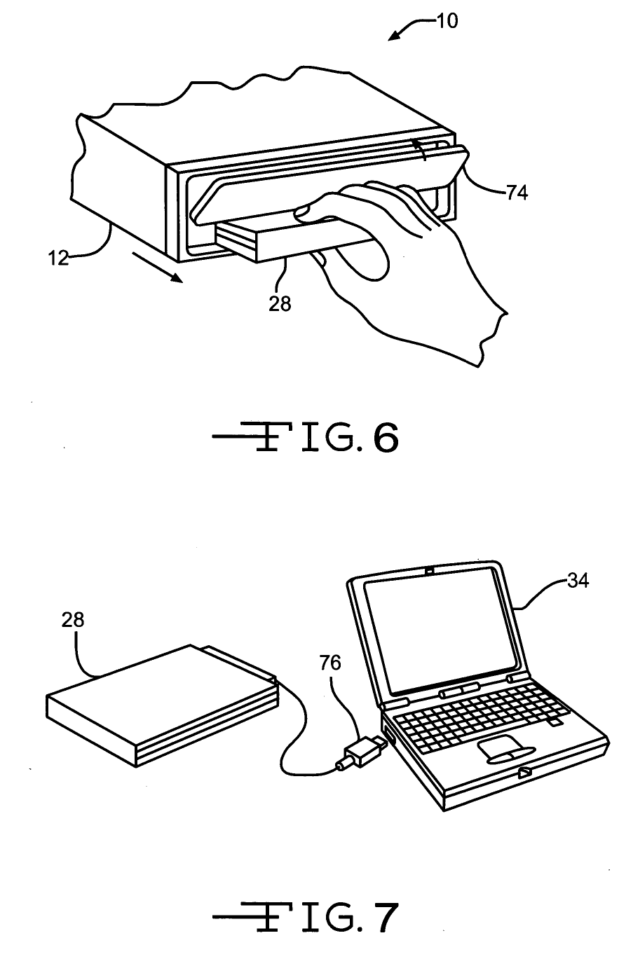

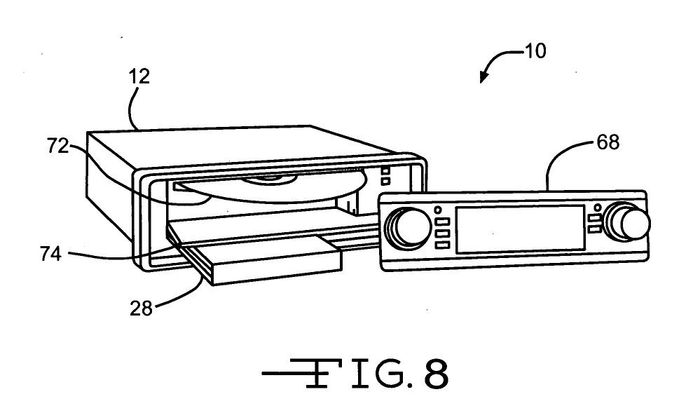

As shown in FIGS. 6 and 8, after removal of or movement to the second position by the face plate 68, a panel 74 attached to the housing 66 behind the face plate 68 is visible from within the occupant compartment of the vehicle. The panel 74 may be removable or may be pivotally connected to the housing 66 to be movable to reveal the hard drive 28. The hard drive 28 may be mounted, connected, and positioned in the audio system 10, so that the hard drive 28 is readily removable from the audio system by a user. The term “readily removable” as used throughout this application means that a user can easily remove and replace the object by hand. The hard drive 28 and the audio system 10 may be connected by any communicably connectable corresponding interfaces, such as IDE/ATA (integrated drive electronics or AT attachment), SCSI (Small Computer System Interface), PCI (Peripheral Component Interconnect) interfaces, USB (Universal Serial Bus), or other multi-pin corresponding interfaces. In a preferred embodiment, the audio system 10 and the hard drive 28 are communicably connected by corresponding USB interfaces. The hard drive 28 includes an interface 76 as illustrated in FIG. 7 for communicably connecting the hard drive 28 and the audio system 10. However, the audio system 10 and the hard drive 28 can be communicably connected by any devices that are communicably connectable to one another to transmit digital data therebetween.

Once the hard drive 28 has been removed from the audio system 10, the interface 76 of the hard drive 28 may communicably connect to the computer 34 or other device 36 that is external from the housing 12, such as another audio system similar to the audio system 10, as described above in reference to FIG. 1. As shown in FIG. 7, the hard drive 28 has been removed from the audio system 10 and has been communicably connected to the external computer 34. It will be appreciated that the computer 34 or other device 36 may retrieve the stored data from the hard drive 28 or may store data on the hard drive 28.

Referring now to FIG. 9, a diagram of the features of the user interface 20 and the face plate 68 in a preferred embodiment of the invention are illustrated, although such features and the illustrated configuration of the face plate 68 is not required. The user interface 20 may include various switches and indicators for selecting and indicating various criteria of the audio system 10. The switches and indicators described herein for the user interface 20 are exemplary and are not intended to limit the invention to the switch and indicator configuration as described. As illustrated, a power switch 101 allows a user to control the power supply of the audio system 10, and the user interface 20 may further indicate if the audio system 10 currently has to power supplied thereto. A source switch 102 allows a user to select a source of musical data for the processing means 22, such as “CD” indicating that the compact disc within the compact disc drive 14 will be the source, “radio” indicating that the tuner 38 will be the source, and “HDD” indicating that the hard drive 28 will be the source of musical data. It will be appreciated that for each of the switches and indicators described herein, a default selection value may be pre-stored or retained from prior use of the audio system 10 and reset upon various criteria for the vehicle. For example, the previously selected source selected using the source switch 102 may be retained after power is terminated to the audio system 10, such that when the vehicle is restarted or the audio system 10 otherwise regains power, the previously selected source of musical data is made the current source of musical data.

The user interface 20 may include a mute switch 103 that allows a user to mute, i.e. reduce or stop the audio output 26, or un-mute the audio output 26. A play switch 104 allows a user to select to play audio representative of the first music track available from the currently selected source, as determined by the source switch 102 or default source value. A play next switch 105 allows a user to select to play the next music track available from the currently selected source, as determined by the source switch 102 or default source value. A play previous switch 106 allows a user to select to play the previous music track available from the currently selected source, as determined by the source switch 102 or default source value.

The user interface may further include a liquid crystal display (LCD) screen 107, although such is not required. Various selected criteria for the audio system 10 and the selected source or track may be displayed on the LCD screen 107. Each of the switches and indicators described herein may be communicably connected to the LCD screen 107, such that the current status or selection of any of the switches and indicators may be displayed on the LCD screen 107. A seek previous switch 108 allows a user to select to seek the previous or lowered numbered frequency or track, depending on the currently selected source, either radio, CD, or HDD, such that approximately 10 seconds of the previous frequency or track is played and then the current frequency or track is advanced to the previous frequency or track, and that frequency or track is played. This play of each previous frequency or track is continued until the user depresses the seek previous switch 108 again or otherwise selects a new function of the audio system 10. A seek next switch 109 works similarly to the seek previous switch 108, except that the seek next switch 109 moves to the next or higher numbered frequency or track of the currently selected source.

A record switch 110 allows a user to select to record a selected source, such as the compact disc within the compact disc drive 14 or the tuner 38 to the hard drive 28. A band switch 111 allows a user to select the band desired for the tuner 38. For example, the band options selected with the band switch 111 may include FM1, FM2, FM3, AM, or digital or satellite radio services. Based on the band selected with the band switch 111, default or preset frequencies for the tuner 38 may be varied, and such preset frequencies may have corresponding selection means within the user interface 20, as will be described below.

The user interface 20 also may include an open switch 112. The open switch 112 may unlock or release the face plate 68 from the audio system 10. A dial 113 may be provided to adjust the treble, bass, fader, balance, and loudness of the audio system 10. The dial may be a conventional dial device for selecting and adjusting multiple audio and speaker settings. A menu switch 114 allows a user to display menu options relating to the data stored within the hard drive 28. The menu switch 114 displays various menu information and options and may display various layers of menu data to allow a user to view and select data from the hard drive 28. The edit switch 115 allows a user to edit song, album, and/or playlist information displayed by the menus generated by the menu switch 114 and the corresponding data.

A plurality of preset switches 116, 117, 118, 119, 120, 121 may be provided in the user interface 20. Each of the preset switches 116, 117, 118, 119, 120, 121 may correspond to a frequency for the tuner 38 and each may vary depending on the currently selected band of the tuner 38, i.e. each preset switch 116, 117, 118, 119, 120, 121 may store a frequency for each available band of the tuner 38. Each of the preset switches 116, 117, 118, 119, 120, 121 may each also have an associated list of criteria representing the tracks available on the hard drive 28. For example, the preset switch 116 may be used to display and select playlists corresponding to selections of the tracks stored of the hard drive 28, such that a user may save a list of selected tracks from the hard drive 28 and then retrieve the list and replay the selected songs using the preset switch 116. In a further example, the preset switch 117 may retrieve an album list from the hard drive 28 that lists tracks on the hard drive 28 by album title. The preset switches 116, 117, 118, 119, 120, 121 may retrieve artist, genre, or song lists from the hard drive 28, and display and allow a user to select and play tracks from the hard drive 28 by any of these criteria. In a preferred embodiment, one of the preset switches 116, 117, 118, 119, 120, 121 allows a user to select to randomly play tracks from a selected playlist, album list, artist list, genre list, or song list. This auto-DJ feature allows the user to select to randomly play tracks from a group of tracks stored on the hard drive 28 matching the selected criteria.

The user interface 20 may also include an auto search button 122. The auto search button may allow a user to search through the currently selected source of tracks. The auto search switch 122 may also function as a station program switch and may work in conjunction with the preset switches 116, 117, 118, 119, 120, 121 to set values of the tuner 38 to correspond to the preset switches 116, 117, 118, 119, 120, 121. A setup switch 123 allows a user to display and modify system settings. A dial 124 may be provided to allow a user to navigate through the menus and information displayed on the LCD display 107.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An audio system configured to be mounted in a vehicle comprising:
a housing;
a processing means communicably connected to a compact disc drive, a user interface, memory, and an audio output, wherein the processing means, compact disc drive, user interface, and memory are disposed within the housing; and
a hard drive disposed within the housing and adapted to be mounted to the housing and communicably connected to the processing means, such that the hard drive is readily removable from the housing;
wherein the hard drive has a storage capacity of at least about 10 Gigabytes;
wherein the processing means is configured to read data from a compact disc within the compact disc drive, encode the data into digitally formatted files, and store the files within at least one of the memory and the hard drive; and
wherein the processing means is configured to send an audio signal representative of the data in the stored files to the audio output.

2. The audio system according to claim 1, wherein the audio system further includes a face plate attached to the housing, the face plate being adapted to be readily removable from the housing.

3. The audio system according to claim 1, wherein the processing means is configured to read, encode, and store the data of the compact disc while simultaneously producing an audio signal representative of the data of the compact disc.

4. The audio system according to claim 1, wherein the audio system is adapted to store the files within at least one of the hard drive and the memory.

5. The audio system according to claim 1, wherein the audio system further comprises a connection for communicably connecting additional memory devices for use by the processing means.

6. The audio system according to claim 1, wherein the hard drive is a removable USB 2.0 hard drive with a capacity of at least about 20 Gigabits.

7. The audio system according to claim 1, wherein the audio system further comprises at least one of an AM tuner, an FM tuner, a digital tuner, and a digital receiver.

8. The audio system according to claim 1 wherein the audio system is adapted to communicate with a device that is external to the housing.

9. The audio system according to claim 1, wherein the compact disc drive is capable of reading and outputting the data stored on the compact disc within the compact disc drive wherein the data is in compact disc digital audio format.

10. The audio system according to claim 1, wherein the processing means is configured to read data from a compact disc within the compact disc drive, encode the data into digitally formatted files, and store the files within the memory, with the reading, encoding, and storing of the data occurring at a rate equal to or faster than a normal rate of play of the data.

11. The audio system according to claim 1, wherein the housing meets the specifications of the single DIN standard.

12. The audio system according to claim 1, wherein the housing meets the specifications of the double DIN standard.

13. The audio system according to claim 1, wherein the memory is integral to the processing means, and the processing means is configured to read data from a compact disc within the compact disc drive, encode the data into digitally formatted files, and store the files within the hard drive.

14. An audio system configured to be mounted in a vehicle comprising:
a housing; and
a processing means communicably connected to a compact disc drive, a user interface, memory, a hard drive, a tuner and an audio output, wherein the processing means, compact disc drive, user interface, hard drive, tuner, and memory are disposed within the housing;
wherein the processing means is configured to read data from a compact disc within the compact disc drive, encode the data into digitally formatted files, and store the files within at least one of the memory and the hard drive;
wherein the processing means is configured to send an audio signal representative of the data in the stored files to the audio output; and
wherein the housing meets the specifications of the single DIN standard.

15. The audio system according to claim 14, wherein the processing means is configured to read data from a compact disc within the compact disc drive, encode the data into digitally formatted files, and store the files within the hard drive, with the reading, encoding, and storing of the data occurring at a rate equal to or faster than a normal rate of play of the data.

16. An audio system configured to be mounted in a vehicle comprising:
a housing; and
a processing means communicably connected to a compact disc drive, a user interface, a hard drive, a tuner, and an audio output, wherein the processing means, compact disc drive, user interface, hard drive, and tuner are disposed within the housing;
wherein the hard drive is readily removable from the audio system and is adapted to be communicably connected to a device that is external to the housing when the hard drive is removed from the audio system
wherein the processing means is configured to read data from a compact disc within the compact disc drive, encode the data into digitally formatted files, and store the files within the hard drive, with the reading, encoding, and storing of the data occurring at a rate equal to or faster than a normal rate of play of the data; and
wherein the processing means is configured to send an audio signal representative of the data in the stored files to the audio output.

17. The audio system according to claim 16, wherein the housing meets the specifications of the single DIN standard.

18. The audio system according to claim 16, wherein the audio system further comprises a hard drive.
